(19) United States
(12) Patent Application Publication
(10) Pub. No.: US 2002/0059578 A1
(43) Pub. Date: May 16, 2002

(54) Digital broadcast receiving method and apparatus

(75) Inventor: Sachiko Nishiura, Tokyo (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: NEC CORPORATION

(21) Appl. No.: 09/986,192

(22) Filed: Nov. 7, 2001

(30) Foreign Application Priority Data
Nov. 10, 2000 (JP) 2000-343728

(51) Int. Cl. H04N 7/16; H04H 9/00; H04N 7/173

(52) U.S. Cl. 725/22; 725/91

(57) ABSTRACT

By pre-setting the hierarchical number in which the files should be retained to record it in a hierarchy designation section 9, upon initiating reception of a data broadcast program in a reception section 1, firstly a start file is acquired in a file acquisition preparation section 5, and retained in a file retention section 6. According to an anchor that is obtained by making a file analysis in a file analysis section 7, the linked files ranging from the start file from the file until a determined hierarchical number are acquired and retained. A trigger for broadcasting reception section 12 is directed from an ES supervisory section 10 so as to supervise ESs. In the event of making transition to a desired file, if a desired file is present within the files that have been retained in advance in the file retention section 6, a file transition section 14 makes the transition hereto.

### BACKGROUND OF THE INVENTION

The present invention relates to digital broadcasting utilizing a ground wave, a broadcasting satellite, a CATV network, or the like, and more particular to a digital broadcast receiving apparatus receiving a data broadcast program that is broadcast by making use of a plurality of elementary streams.

The digital broadcasting has been realized that broadcasts video and voice with a digital signal due to a remarkable progress in recent digital signal processing technology such as a compression technology of video and voice and so forth.

Also, development of the technology has been done flourishingly for realization of the digital broadcasting that broadcasts a data program in the stream of fusion of communication and broadcasting.

In the data broadcasting of the digital broadcasting that conformed to the specification of MPEG-2, a plurality of files constituting the program are broadcast from a transmitting apparatus, and the receiving apparatus receives the file according to necessity, displays its contents on a screen, and outputs the voice.

This file is transferred (broadcast) by a bit stream called an Elementary Stream (hereinafter, referred to as ES). Additionally, it is referred to as a multi-ES that a plurality of files are broadcast with a plurality of the ESs.

The ES including the data broadcasting can be identified by a descriptor indicating that the data broadcast program is being broadcast. Also, the ES, with which the file of a starting part of the program (hereinafter, referred to as a start file) is being transferred, can be specified from within the files constituting the data broadcast program by a component_tag value, and the start file can be identified by ID (module_ID and so forth) from the other files. In the event that it is necessary to link to the other file, an anchor including the component tag value specifying the ES for linking to the other file is included in the start file. There is the case in which the anchor for further linking to the other file is included in the other file as well.

As to an operation of the case in which the conventional receiving apparatus receives the data broadcast program, firstly, the ES in which data is included is selected by the descriptor and the component_tag value, and the ES with which the start file is being transferred is specified from within a receiving signal. Next, the start file is identified and acquired by the ID of the file from the specified ES to make screen display or voice output for its contents. When initiation of transition to a link destination is executed, the receiving apparatus acquires the file of a link destination designated by the anchor from a predetermined ES to make the screen display or the voice output for its content.

The conventional receiving apparatus acquires the file of the link destination from the predetermined ES after initiation of the transition to the link destination was executed. In a multi-ES form in which the data broadcast program are constructed of a plurality of the ESs, so as to make transition to the file that is being transferred with the other ESs, firstly, the ESs are filtered to specify a desired ES, and then the file needs to be acquired from its ES. Accordingly, at the time when the transition to the link destination was executed by a user's operation, it took a long time until the next screen was displayed, whereby comfortable operability is no be able to be realized.

### SUMMARY OF THE INVENTION

Accordingly, the objective of the present invention is to provide the digital broadcasting receiving apparatus that realized comfortable operability in which there is a little waiting time at the moment of making the transition to the link destination in the data broadcasting reception and which also can correspond to the user's quick operation.

In order to accomplish the above-mentioned objective, the digital broadcast receiving method of the present invention is a digital broadcast receiving method for receiving the data broadcasting in which a plurality of the files are broadcast with a plurality of the elementary streams to make the screen display and the voice output, wherein: the hierarchical number in which said files should be retained is determined in advance; upon initiating reception of said data broadcasting, a start file, which is a first file of said data broadcasting, is acquired from a determined elementary stream to retain the above start file; by analyzing said file, also in the event that the elementary streams with which respective said files are broadcast differ from each other, said files linked by the anchors within each of the files ranging from the start file to the file until said hierarchical number are acquired automatically and retained: and the screen display is made by use of said files that have been retained.

In accordance with the present invention, the instant the reception of the data broadcast program is initiated, the files that amounts to the pre-set hierarchical number are automatically acquired from respective ESs, whereby, by acquiring the file of the link destination before the transition to the link destination is executed by the user's operation and so forth, the screen display can be made instantly at the time of making the transition to the link destination.

The other digital broadcast receiving method of the present invention is a digital broadcast receiving method for receiving the data broadcasting in which a plurality of the files are broadcast with a plurality of the elementary streams to make the screen display and the voice output, wherein: upon initiating reception of said data broadcasting, a start file, which is a first file of said data broadcasting, is acquired from a determined elementary stream to retain the above start file; by analyzing said file, also in the event that the elementary streams with which respective said files are broadcast differ from each other, all said files linked by the anchors within each file are acquired automatically and retained; and the screen display is made by use of said files that have been retained.

In accordance with the present invention, the instant the reception of the data broadcast program is initiated, the linked files are acquired automatically, whereby, by acquiring the file of the link destination before the transition to the link destination is executed by the user's operation and so forth, the screen display can be made instantly at the time of making the transition to the link destination.

In accordance with the embodiment of the present invention, all said elementary streams with which the files that were received in advance and retained are being broadcast are constantly supervised and a trigger for broadcasting that is to be broadcast is received.

In accordance with the present embodiment, during the reception of the data broadcasting, all elementary streams with which the acquired files are being transferred are constantly supervised to receive the trigger for broadcasting, whereby the trigger for broadcasting also can be applied during the reception of the data broadcasting.

In accordance with the embodiment of the present invention, contents that said trigger for broadcasting indicates is reflected on said files that were acquired in advance and retained.

In accordance with the present embodiment, during the reception of the data broadcasting, all elementary streams with which the acquired files are being transferred are constantly supervised to receive the trigger for broadcasting, whereby reflection can be made on the files that have been acquired in advance. For example, when a version-up is notified with the broadcasting trigger, the already-acquired files can be upgraded into the newest file.

The digital broadcast receiving apparatus of the present invention is a digital broadcast receiving apparatus that receives the data broadcasting in which a plurality of the files are broadcast with a plurality of the elementary streams to make the screen display and the voice output, comprising: hierarchy designation means for storing the pre-determined hierarchical number in which said files should be retained; upon initiating reception of said data broadcasting, file acquisition preparation means for acquiring and retaining a start file, which is a first file of said data broadcasting, from an elementary stream with which the above start file is broadcast, by analyzing said file, also in the event that the elementary streams with which respective said files are broadcast differ from each other, to automatically acquire and retain said files linked by said anchor within each of the files ranging from said start file to the file until said hierarchical number; and file transition means for making the screen display by use of said files that have been retained.

The other digital broadcast receiving apparatus of the present invention is a digital broadcast receiving apparatus that receives the data broadcasting in which a plurality of the files are broadcast with a plurality of the elementary streams to make the screen display and the voice output, comprising: upon initiating reception of said data broadcasting, file acquisition preparation means for acquiring and retaining a start file, which is a first file of said data broadcasting, from an elementary stream with which the above start file is broadcast, by analyzing said file, also in the event that the elementary streams with which respective said files are broadcast differ from each other, to automatically acquire and retain all said files linked by the anchors within each file; and file transition means for making the screen display by use of said files that have been retained.

In accordance with the embodiment of the present invention, it further comprises trigger for broadcasting reception means for constantly supervising all said elementary streams with which said files, which were received in advance and retained, are being broadcast, to receive a trigger for broadcasting that is to be broadcast.

In accordance with the embodiment of the present invention, it further comprises trigger for broadcasting reflection means for causing contents, which said trigger for broadcasting indicates, to be reflected on said files that were acquired in advance and retained.

### BRIEF DESCRIPTION OF THE DRAWING

This and other objects, features and advantages of the present invention will become more apparent upon a reading of the following detailed description and drawings, in which:

FIG. 1 is a block diagram illustrating a structure of a digital broadcast receiving apparatus of one embodiment of the present invention;

FIG. 2 is a flowchart illustrating an operation of a digital broadcast receiving apparatus of the present embodiment;

FIG. 3 is a flowchart illustrating an operation of a digital broadcast receiving apparatus in a process A of FIG. 2;

FIG. 4 is a flowchart illustrating an operation of a digital broadcast receiving apparatus in a process B of FIG. 2;

FIG. 5 is a flowchart illustrating an operation of a digital broadcast receiving apparatus in a process C of FIG. 2;

FIG. 6 is a view illustrating one example of a file structure of a data broadcast program for explaining an operation of a digital broadcast receiving apparatus of the present embodiment; and

FIG. 7 is a view illustrating one example of relation between files constituting a data broadcast program and ESs in which these files are being transferred for explaining an operation of a digital broadcast receiving apparatus of the present embodiment.

### DESCRIPTION OF THE EMBODIMENTS

The digital broadcast receiving apparatus of the present invention is an apparatus that, before the transition among the files is designated by the user's operation, by acquiring and storing a plurality of the files, which are transferred (broadcast) in the multi-ES, from the ESs with which respective files are transferred, employs the file that has been retained as the file of the transition destination at the moment of switching the screen display and the voice output by the user's operation.

An embodiment of the present invention will be explained in details in reference to the accompanied drawings.

Firstly, a structure of the digital broadcast receiving apparatus of one embodiment of the present invention will be explained.

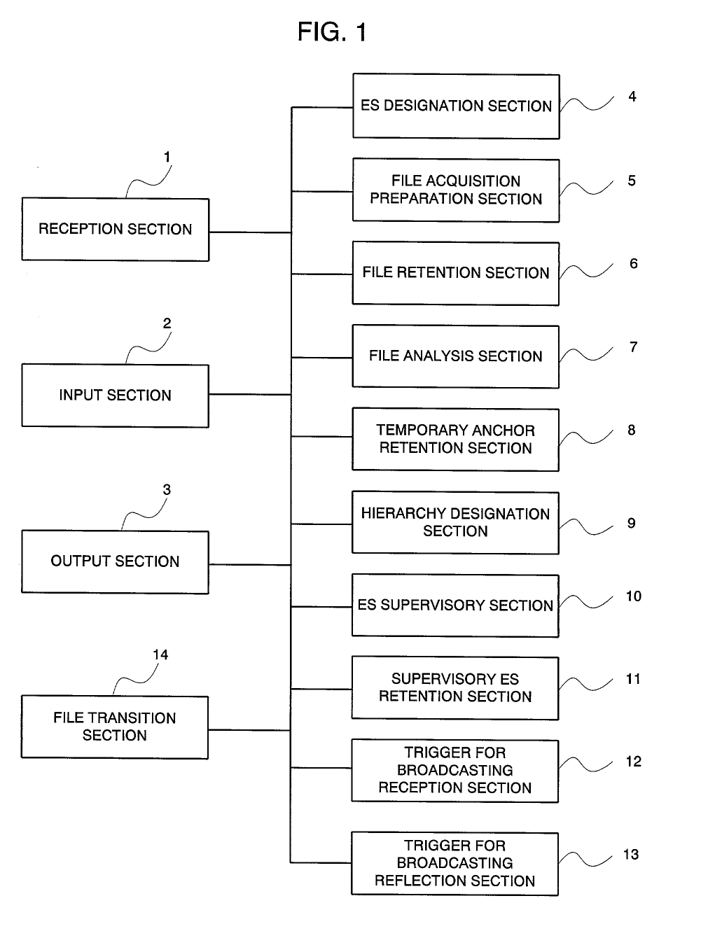

In reference to FIG. 1, the digital broadcast receiving apparatus of the present embodiment includes a reception section 1, an input section 2, an output section 3, an ES designation section 4, a file acquisition preparation section 5, a file retention section 6, a file analysis section 7, a temporary anchor retention section 8, a hierarchy designation section 9, an ES supervisory section 10, a supervisory ES retention section 11, a trigger for broadcasting reception section 12, a trigger for broadcasting reflection section 13, and a file transition section 14.

The reception section 1 receives a signal of the digital broadcasting transmitted from a transmitting apparatus (not shown). For example, a radio signal is received in the ground wave digital broadcasting.

The input section 2 is a user interface that a user operates for execution of the transition to the link destination and so forth.

The output 3 makes the screen display or the voice output for contents of the digital broadcasting.

The ES designation section 4 designates the ES from which the file should be acquired. When a user operates the input section 2 to select a different file from the file that is being displayed, if the selected file is being transferred with the same ES as the file that is under display, the designation of the ES as it stands is continued, and if it is being transferred with the different ES, it is designated. Also, the ES is designated in according to the anchor that was detected in the file analysis section 7 and was stored in the temporary anchor retention section 8.

The file acquisition preparation section 5 acquires data of a desired file from the ES designated in the ES designation section 4, and prepares a new file to retain it in the file retention section 6.

The file retention section 6 stores the file prepared in the file acquisition preparation section 5.

The file analysis section 7 analyzes the file retained in the file retention section 6, and retrieves the anchor described within the file. In the event of having detected a new anchor by retrieving, the file analysis section 7 retains its anchor in the temporary anchor retention section 8.

The temporary anchor retention section 8 stores the anchor detected in the file analysis section 7.

The hierarchy designation section 9 stores in advance the hierarchical number of the files that should be analyzed and retained. This hierarchical number is the hierarchical number since the start file. The hierarchical number is a setting value that is changeable, for example, by a user; however it may be a fixed value by a design, or a value that is set at the time of shop delivery.

The ES supervisory section 10 checks whether or not the ES with which the acquired file is being transferred is an ES registered in the supervisory ES retention section 11, which is now under supervision, and if it is not under supervision, it notifies the trigger for broadcasting reception section 12, and registers the ES name to the supervisory ES retention section 11.

Herein, what is referred to as the supervision is to keep the trigger for broadcasting reception section 12 in a situation that, if the trigger for broadcasting is present in the ES, it can be surely received. What is referred to as the trigger for broadcasting is information that is broadcast for notifying the digital broadcast receiving apparatus of something of which contents is a version-up of the file, an event message, and an beginning of emergent broadcasting and so forth, which is included in the ES and yet is transferred.

The supervisory ES retention section 11 stores the ES name of the ES under supervision (for example, the component_tag value).

When the trigger for broadcasting reception section 12 receives the trigger for broadcasting within the ES notified from the ES supervisory section 10, it notifies the trigger for broadcasting reflection section 13 of it.

The trigger for broadcasting reflection section 13 causes the trigger for broadcasting notified from the trigger for broadcasting reception section 12 to be reflected on the operation of the digital broadcast receiving apparatus and the acquired file. For example, if the trigger for broadcasting is a trigger indicating the beginning of emergent broadcasting, while the digital broadcast receiving apparatus performs the other reception operation, it simultaneously receives the emergent broadcasting. Also, for example, if the trigger for broadcasting is a trigger indicating the version-up of the file that has already been acquired, effort of the acquisition of the newest file is caused to be reflected on the operation.

The file transition section 14 controls the transition to the other desired file by the user's operation and so forth, and carries out the screen display for the output section 3.

Next, the operation of the digital broadcast receiving apparatus of the present embodiment will be explained.

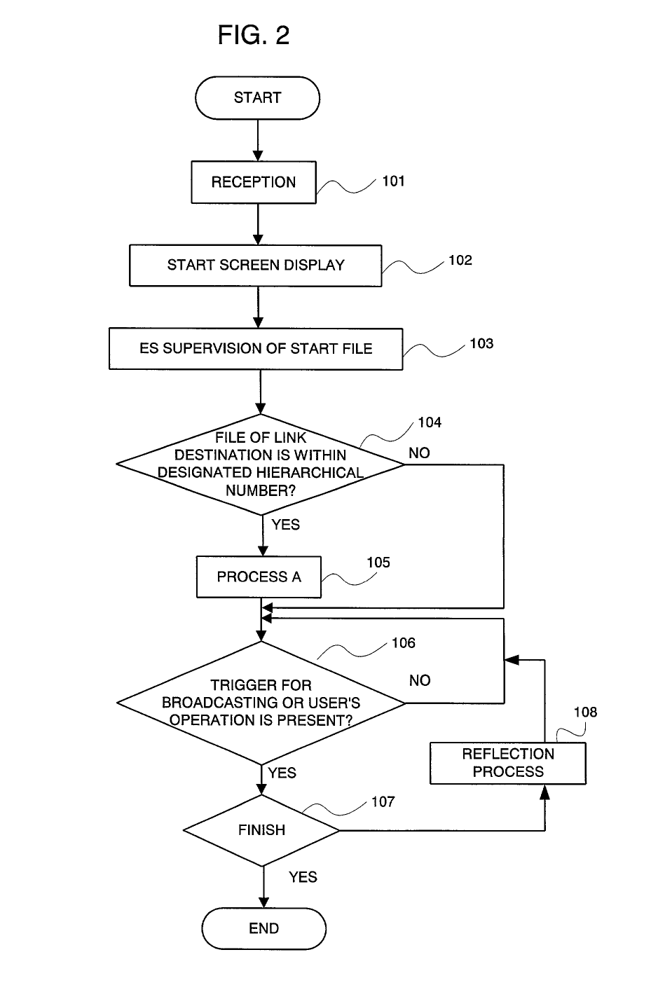

FIG. 2 is a flowchart illustrating the operation of the digital broadcast receiving apparatus of the present embodiment.

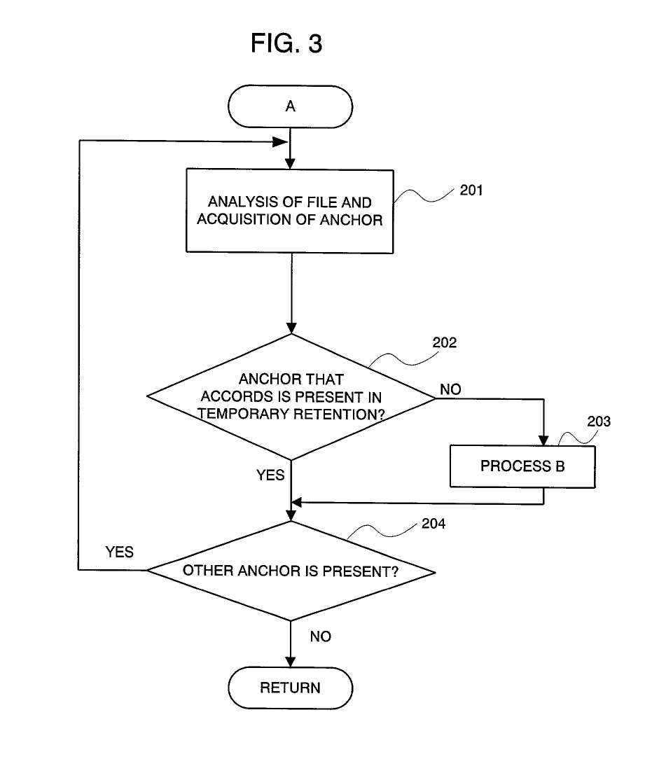

FIG. 3 is a flowchart illustrating the operation of the digital broadcast receiving apparatus in a process A of FIG. 2.

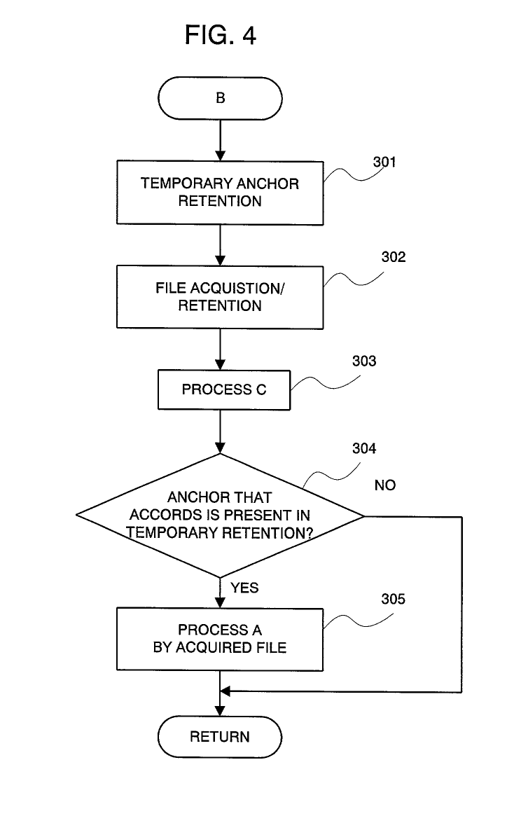

FIG. 4 is a flowchart illustrating the operation of the digital broadcast receiving apparatus in a process B of FIG. 3.

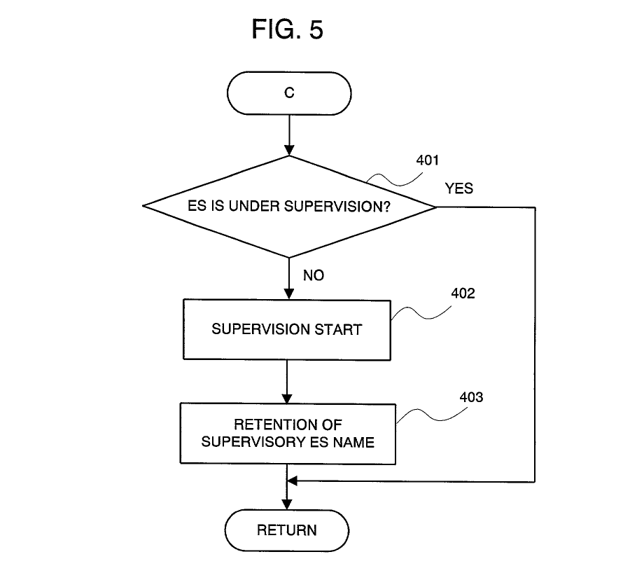

FIG. 5 is a flowchart illustrating the operation of the digital broadcast receiving apparatus in a process C of FIG. 4.

In reference to FIG. 2, after the digital broadcast receiving apparatus came to be in a situation that the data broadcasting was able to be received by having performed an initialization process and so forth, firstly, it initiates the reception of the data broadcasting in the reception 1 (step 101). At first, since the start file is acquired from a determined ES, the screen display or the voice output is made for its contents in the output section 3 (step 102).

The digital broadcast receiving apparatus checks in the ES supervisory section 10 whether or not the ES with which the start file is being transferred was stored in the supervisory ES retention section 11 (namely, under supervision or nor); however, since it is not under supervision at the beginning, it causes the ES supervisory section 10 to notify and supervise the trigger for broadcasting reception section 12 of its ES, and simultaneously causes the supervisory ES retention section 11 to retain its ES name (step 103),

Next, the digital broadcast receiving apparatus confirms in the file analysis section 7 the hierarchical number pre-set in the hierarchy designation section 9, and determines whether or not the file of the link destination from the start file is within the designated hierarchical number (step 104).

Next, if the file of the link destination is within the designated hierarchical number, the digital broadcast receiving apparatus performs the operation of the process A (step 105); however if not within the designated hierarchical number, the operation of the process A is not performed. Herein, it is the case that the designation by the hierarchy designation section 9 is the hierarchical number “0” that it is determined that it is not within the designated hierarchical number.

What is referred to as the operation of the process A is an operation that, so as to confirm the files that amounts to the designated hierarchical number, which include the files that are transferred with the different ESs, retrieves the anchor described within the files to detect the file of the link destination, acquires its file from the ES with which it is being transferred, further initiates the supervision of the ES with which its file is being transferred; however the detailed contents will be described later.

For example, if the hierarchical number “2” was designated in the hierarchy designation section 8, in the event that the file structure of the data broadcast program was two or more hierarchies, the digital broadcast receiving apparatus acquires the files that amounts to two hierarchies. In the event that the file structure of the data broadcast program was below two hierarchies, the digital broadcast receiving apparatus acquires the files that amount to all hierarchies.

Also, “all”, which designates all hierarchies instead of the hierarchical number, can be set in the hierarachy designation section 9, and in the event that its “all” was designated, the digital broadcast receiving apparatus acquires the files of all hierarchies also in the event that the files relating to the data broadcast program are being broadcast with the ESs that differ from each other.

Next, in the step 104, in the event that the file of the link destination was not within the designated hierarchical number, and in the event that the process A of the step 105 was finished, the trigger for broadcasting or occurrence of the operation by a user is supervised (step 106).

When the digital broadcast receiving apparatus detects the trigger for broadcasting or the user's operation, it determines whether or not its trigger for broadcasting or its user's operation is one that indicates termination of the reception of the data broadcast program (step 107). If it is one that indicates termination of the reception of the data broadcast program, the process is finished, and if not, the process instructed by the trigger for broadcasting or the user's operation is caused to be reflect on the operation to return to the process of the step 106.

Next, the operation of the digital broadcast receiving apparatus in the foregoing process A will be explained.

In reference to FIG. 3, firstly, in the foregoing process A, the digital broadcast receiving apparatus analyzes the start file in the file analysis section 7 to detect an anchor (step 201).

Next, the digital broadcast receiving apparatus compares in the file analysis section 7 the detected anchor with contents stored in the temporary anchor retention section 8, and determines whether or not one that accords is present (step 202).

Next, if one that accords is not present in the temporary anchor retention section 8, the digital broadcast receiving apparatus executes the process B (step 203); however if one that accords is present, it does not execute the process B.

What is referred to as the operation of the process B is an operation that: in the event that the file, which becomes the link destination in the detected anchor, is present in the file retention section 6, acquires its file from it; in the event that it is not present in the file retention section 6, acquires its file from the ES with which its file is transferred, initiates the supervision of the ES with which its file is transferred; and if the link from the acquired file is within the hierarchical number designated in the hierarchy designation section 9, executes the process A for the acquired file, but the detailed operation will be explained later.

Next, in the event that the anchor that accorded in the step 202 was present, and in the event that the process B of the step 203 was finished, it is determined whether or not the other anchor is present within the file (step 204), and if the anchor is not present within the file, the operation of the process A is finished to proceed to the step 106 in FIG. 2.

If the other anchor is present, the operation returns to the step 201, and the process A is executed for its anchor. And, the operation of the process A is repeated until the operation is finished for all anchors within the file.

Next, the operation of the digital broadcast receiving apparatus in the foregoing process B will be explained.

In reference to FIG. 4, in the process B, the digital broadcast receiving apparatus stores the detected anchor in the temporary anchor retention section 8 (step 301), and acquires the file, which becomes the link destination in its anchor, in the file acquisition preparation section 5 (step 302). At this moment, if its file is present in the file retention section 6, its file is acquired from the file retention section 6, and if not present in the file retention section 6, the ES with which its file is being transferred is designated in the ES designation section 4 to acquire the file and to cause the file retention section 6 to retain it.

Next, the digital broadcast receiving apparatus executes the process C (step 303).

What is referred to as the operation of the process C is an operation that determines whether or not the ES designated in the ES designation section 4 is under supervision, and if not under supervision, initiates supervision; however the detailed operation will be described later.

Next, the digital broadcast receiving apparatus determines whether or not the link destination from the file acquired in the step 302 is within the hierarchical number designated in the ES designation section 4 (step 304), and if it is within the hierarchical number, it executes the process A for its file (step 305), and then finishes the operation of the process B to proceed to the step 204 in FIG. 3.

In the determination of the step 304, if it is determined to be not within the hierarchical number, the process B is finished as it stands to proceed to the step 204 in FIG. 3.

Next, the operation of the digital broadcast receiving apparatus in the foregoing process C will be explained.

In reference to FIG. 5, in the process C, the digital broadcast receiving apparatus determines in the ES supervisory section 10 whether or not the ES with which the acquired file was transferred was stored in the supervisory ES retention section 11 (namely, under supervision or not) (step 401).

If its ES is already under supervision, the process C is finished to proceed to the step 304 in FIG. 4.

If its ES is not under supervision, the supervision of its ES is initiated (step 402), the ES name of its ES is retained in the supervisory ES retention section 11 (step 403), and then the process C is finished to proceed to the step 304 in FIG. 4.

For example, herein, if the user's operation is present, the transition is made to the other file in accordance with the user's operation in the file transition section 14 to make the screen display and the voice output; however if the transition is a transition to the file stored in the file retention section 6, the screen display and so forth can be made instantly.

Upon initiating the reception of the data broadcast program, by analyzing the acquired file, the digital broadcast receiving apparatus of the present embodiment identifies the file of the link destination also in the event that it is being transferred with the different ES, automatically acquires the file of the link destination, which amounts to the hierarchical number pre-set in the hierarchy designation section 9, before the transition is executed by the user's operation and so forth, and instantly makes the screen display and so forth at the time of making the transition to the link destination, whereby comfortable operability can be offered to a user without causing a user to wait by switching the screen.

Also, during the operation of receiving the data broadcasting, the acquired file constantly supervises all ESs with which the acquired files are being transferred, whereby, even though there is the version-up and so forth for the file that has been acquired in advance, the newest file can be acquired, whereby the data broadcast program with the file having the newest version-up can be constantly offered to a user.

Next, the specific operation of the digital broadcast receiving apparatus of the present embodiment will be explained by use of one example of the data broadcast program.

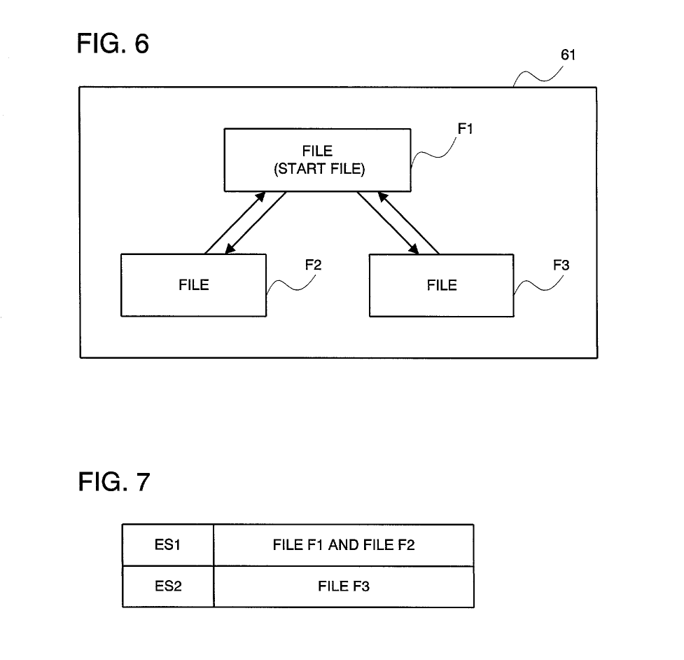

FIG. 6 is a view illustrating one example of a file structure of the data broadcast program for explaining the operation of the digital broadcast receiving apparatus of the present embodiment. Arrows in FIG. 6 indicates link relation by the anchor.

In reference to FIG. 6, a data broadcast program 61 shown as one example is constructed of a file F1, a file F2 and a file F3, the file F1 and the file F2 are linked to each other by the anchor, and the file F1 and the file F3 are also linked to each other by the anchor. Also, the file F1 is set at the start file.

FIG. 7 is a view illustrating one example of relation between the files constituting a data broadcast program and the ESs with which these files are being transferred for explaining the operation of the digital broadcast receiving apparatus of the present embodiment.

In reference to FIG. 7, the file F1 and the file F2 are transferred with the ES 1, and the file F3 are transferred with the ES 2.

As to the operation of the digital broadcast receiving apparatus in the event of receiving the data broadcast program 61, firstly, in the step 101, the file F1 that is the start file is acquired from the ES1 to display a start screen in the step 102.

Since the file F1 is transferred with the ES1 as shown in FIG. 7, the digital broadcast receiving apparatus checks whether or not the ES 1 is under supervision. Herein, since the ES 1 is not under supervision, in the step 103, the digital broadcast receiving apparatus initiates the supervision of the ES 1, and simultaneously retains the ES name of the ES 1 in the supervisory ES retention section 11.

Next, the digital broadcast receiving apparatus confirms the hierarchical number pre-set in the hierarchy designation section 9, and determines in the step 104 whether or not the file of the link destination from the start file is within the designated hierarchical number.

Herein, if the hierarchical number “2” has been set in the hierarchy designation section 9, since the file of the link destination is within the hierarchical number, the operation proceeds to the process A of the step 105.

In the step 201, the digital broadcast receiving apparatus analyzes the file F1 in the process A to detect the anchor. Herein, as shown in FIG. 7 the anchor that becomes the link to the file F2 and the file F3 was described in the file F1; however firstly the anchor to the file F2 is detected. As a described example of the anchor to the file F2, it is “ARIB://ES1/file F2”.

In the step 202, the digital broadcast receiving apparatus compares the anchor to the file F2 with contents of the temporary anchor retention section 8, and determines whether or not one that accords is present. Herein, since one that accords is not present, the operation B of the step 203 is performed.

In the step 301 of the process B, the digital broadcast receiving apparatus retains the anchor in the temporary anchor retention section 8, and, in the step 302, acquires the file F2 that corresponds to its anchor to retain it in the file retention section 6.

Next, the digital broadcast receiving apparatus executes the operation of the process C. In the process C, it is determined in the step 401 whether or not the ES in which the file was broadcast is under supervision.

Herein, as shown in FIG. 7, the file F2 is being broadcast with ES 1. Also, since this ES 1 is already under supervision, the process C is finished.

Next, the digital broadcast receiving apparatus determines in the step 304 whether or not the file F2 is within the designated hierarchical number “2” designated in the hierarchy designation section 8. Herein, since it is within the hierarchical number, the process A is executed for the file F2.

In the step 201 of the process A shown in FIG. 3, the digital broadcast receiving apparatus analyzes the file F2 to detect the anchor, and acquires the anchor to the file F1 as shown in FIG. 6.

The digital broadcast receiving apparatus checks in the step 202 whether or not the anchor to the file F1 was recorded in the temporary anchor retention section 9. Herein, since it was already recorded, the process B is not executed for its anchor. And, it is determined in the step 204 whether or not the other anchor is present.

Herein, since the other anchor is not present, the operation of the process A is finished for the file F2, and simultaneously the operation of the process B for the anchor from the file F1 to the file F2 is also finished.

Next, it is determined in the step 204 of the process A for the file F1 whether or not the other link is present in the file F1. Herein, since the anchor (The description is “ARIB://ES2/File F3”) that links to the file F3 is present within the file F1, its anchor is detected in the step 201, and it is determined in the step 202 whether or not its anchor was stored in the temporary anchor retention section 9.

Herein, since its anchor has not been stored yet, in the step 203, the operation of the process B is executed for its anchor.

In the process B, in the step 301, its anchor is retained in the temporary anchor retention section 9, and in the step 302, the file F3 is acquired. For example, if the file F3 has not been retained in the retention section 6 yet, the file F3 is newly acquired from the ES 2.

Since the file F3 is being transferred with the ES 2 as shown in FIG. 7, the ES 2 is designated in the ES designation section 4 to acquire the file F3 within it and to retain it in the file retention section 6.

Next, the digital broadcast receiving apparatus executes the process C in the step 303. In the process C, it is determined in the step 401 whether or not the ES 2 is under supervision. Herein, since the ES 2 is not under supervision, the supervision of the ES 2 is initiated in the step 402, and in the step 403, the ES name of the ES 2 is retained in the supervisory ES retention section 11 to finish the operation of the process C.

Next, it is determined in the step 304 in FIG. 4 whether or not the file of the link destination from the file F3 is within the hierarchical number “2” designated in the file hierarchy designation section 9. Herein, since it is within the designated hierarchical number, the operation of the process A is executed for the file F3.

In the step 201 of the process A, the file F3 is analyzed to acquire an anchor. Herein, the anchor to the file F1 is acquired. It is determined in the step 202 whether or not this anchor was stored in the temporary anchor retention section 8; however since it was already stored, the process B is not executed. Also, it is determined in the step 204 whether or not the other anchor is present; however since it is not present, the process A is finished. Together therewith, the process B for the anchor from the file F3 to the file F1 is finished.

Returning to the step 204 of the process A for the file F1, it is determined whether or not the other anchor is present within the file F1. Herein, since the other anchor is not present, the process A for the file F1 is finished entirely to return to the step 106.

And, in the step 106, the digital broadcast receiving apparatus supervises the trigger for broadcasting or occurrence of the operation by a user.

For example, if here is the user's operation, by making the transition to the other file according to the user's operation in the file transition section 14, the screen display is made; however since all of the file F1, the file F2, and the file F3 were stored in the file retention section 6, the screen display can be made instantly.

In accordance with the present invention, the instant the reception of the data broadcasting program is initiated, the files that mounts to the pre-set hierarchical number or all linked files are automatically acquired, whereby, by acquiring the file of the link destination before the transition to the link destination is executed by the user's operation and so forth, the screen display can be made instantly at the time of making the transition to the link destination, whereby comfortable operability can be offered to a user without causing a user to wait by switching the screen.

Also, according to the embodiment, during the reception of the data broadcasting, all elementary streams with which the acquired files are being transferred are constantly supervised, and if the trigger for broadcasting is transferred, it is received, whereby the trigger for broadcasting can be applied also during the reception of the data broadcasting, whereby the program with the newest status can be offered to a user.

Also, if the trigger for broadcasting is information that should be reflected on the file that has been acquired in advance, it can be reflected. For example, when the version-up of the file is notified with the trigger for broadcasting, the already-acquired file can be up-graded into the newest version, whereby the program with the newest file can be offered to a user.

The entire disclosure of Japanese Application No. 2000-343728 filed on Nov. 10, 2000 including specification, claims, drawings and summary are incorporated herein by reference in its entirely.

What is claimed is:

1 A digital broadcast receiving method for receiving data broadcasting in which a plurality of files are broadcast with a plurality of elementary streams to make screen display and voice output, wherein hierarchical number in which said files should be retained is determined in advance, and
wherein, upon initiating reception of said data broadcasting, a start file, which is a first file of said data broadcasting, is acquired from a determined elementary stream to retain said start file, and
wherein, by analyzing said file, also in case that elementary streams with which respective said files are broadcast differ from each other, said files linked by anchors within each of said files ranging from said start file to said file until said hierarchical number are acquired automatically and retained, and
wherein screen display is made by use of said files that have been retained.

2 A digital broadcast receiving method for receiving data broadcasting in which a plurality of files are broadcast with a plurality of elementary streams to make screen display and voice output,
wherein, upon initiating reception of said data broadcasting, a start file, which is a first file of said data broadcasting, is acquired from a determined elementary stream to retain said start file, and
wherein, by analyzing said file, also in case that elementary streams with which respective said files are broadcast differ from each other, all said files linked by anchors within each file are acquired automatically and retained, and
wherein screen display is made by use of said files that have been retained.

3 The digital broadcast receiving method according to claim 1,
wherein all said elementary streams with which said files that were received in advance and retained are being broadcast are constantly supervised, and
wherein a trigger for broadcasting that is to be broadcast is received.

4 The digital broadcast receiving method according to claim 3, wherein contents that said trigger for broadcasting indicates is caused to be reflected on said files that were acquired in advance and retained.

5 A digital broadcast receiving apparatus receiving data broadcasting in which a plurality of files are broadcast with a plurality of elementary streams to make screen display and voice output, comprising;
hierarchy designation means for storing pre-determined hierarchical number in which said files should be retained;
upon initiating reception of said data broadcasting, file acquisition preparation means for acquiring and retaining a start file, which is a first file of said data broadcasting, from an elementary stream with which said start file is broadcast, by analyzing each file, also in case that said elementary streams with which respective said files are broadcast differ from each other, to automatically acquire and retain said files linked by anchors within each of said files ranging from said start file to said file until said hierarchical number; and
file transition means for making screen display by use of said files that have been retained.

6 The digital broadcast receiving apparatus according to claim 5, further comprising trigger for broadcasting receiving means for constantly supervising all said elementary streams with which said files that were received in advance and retained are being broadcast to receive a trigger for broadcasting that is to be broadcast.

7 The digital broadcast receiving apparatus according to claim 6, further comprising trigger for broadcasting reflection means for causing contents, which said trigger for broadcasting indicates, to be reflected on said files that were acquired in advance and retained.

8 A digital broadcast receiving apparatus receiving data broadcasting in which a plurality of files are broadcast with a plurality of elementary streams to make screen display and voice output, comprising;
upon initiating reception of said data broadcasting, file acquisition preparation means for acquiring and retaining a start file, which is a first file of said data broadcasting, from an elementary stream with which said start file is broadcast, by analyzing each file, also in case that said elementary streams with which respective said files are broadcast differ from each other, to automatically acquire and retain all said files linked by anchors within each file; and
file transition means for making screen display by use of said files that have been retained.

9 The digital broadcast receiving apparatus according to claim 8, further comprising trigger for broadcasting receiving means for constantly supervising all said elementary streams with which said files that were received in advance and retained are being broadcast to receive a trigger for broadcasting that is to be broadcast.

10 The digital broadcast receiving apparatus according to claim 8, further comprising trigger for broadcasting reflection means for causing contents, which said trigger for broadcasting indicates, to be reflected on said files that were acquired in advance and retained.
